(19) United States
(12) Patent Application Publication
(10) Pub. No.: US 2014/0215158 A1
(43) Pub. Date: Jul. 31, 2014

(54) Executing Requests from Processing Elements with Stacked Memory Devices

(71) Applicant: HEWLETT-PACKARD DEVELOPMENT COMPANY, (US)

(72) Inventors: Onur Kocberber, Lausanne (CH); Kevin T. Lim, La Honda, CA (US); Parthasarathy Ranganathan, San Jose, CA (US)

(73) Assignee: HEWLETT-PACKARD DEVELOPMENT COMPANY, L.P., Houston, TX (US)

(21) Appl. No.: 13/755,661

(22) Filed: Jan. 31, 2013

(51) Int. Cl. G06F 12/08

(52) U.S. Cl. CPC G06F 12/0811
USPC 711/122

(57) ABSTRACT

Executing requests from processing elements with stacked memory devices includes receiving a request from a processing element, determining which of multiple memory devices contains information pertaining to the request, forwarding the request to a selected memory device of the memory devices, and responding to the processing element with the information in response to receiving the information from the selected memory device.

### BACKGROUND

When a processing element generates an indexing request, the request is executed by traversing data points in data structures to find relevant information. Each of the traversed data points is sent to the processing element where the data point is stored temporarily during the execution of the indexing request.

### BRIEF DESCRIPTION OF THE DRAWINGS

The accompanying drawings illustrate various examples of the principles described herein and are a part of the specification. The illustrated examples are merely examples and do not limit the scope of the claims.

FIG. 1 is a diagram of an example of hardware for executing an indexing request according to the principles described herein.

FIG. 2 is a diagram of an example of an executing engine according to the principles described herein.

FIG. 3 is a diagram of an example of higher levels of a data structure according to the principles described herein.

FIG. 4 is a diagram of an example of lower levels of a data structure according to the principles described herein.

FIG. 5 is a diagram of an example of a method for executing indexing requests according to the principles described herein.

FIG. 6 is a diagram of an example of a method for executing indexing requests according to the principles described herein.

FIG. 7 is a diagram of an example of an executing system according to the principles described herein.

FIG. 8 is a diagram of an example of an executing system according to the principles described herein.

FIG. 9 is a diagram of an example of a flowchart of a process for executing indexing requests according to the principles described herein.

### DETAILED DESCRIPTION

Sending all of the traversed data points to the processing element spends unnecessary amounts of energy and uses up the processing element's limited memory. The principles described herein restrict the data sent to the processing element to just the relevant data pertaining to the indexing request by incorporating an executing engine between the stored data and the processing element. The executing engine performs part of the indexing request. The other part of the indexing request is performed internal to the memory devices that store the sought after data.

The principles described herein include a method for executing requests from processing elements with stacked memory devices. Such a method includes receiving a request from a processing element, determining which of multiple memory devices contains information pertaining to the request, forwarding the request to a selected memory device of the memory devices, and responding to the processing element with the information in response to receiving the information from the selected memory device.

In the following description, for purposes of explanation, numerous specific details are set forth in order to provide a thorough understanding of the present systems and methods. It will be apparent, however, to one skilled in the art that the present apparatus, systems, and methods may be practiced without these specific details. Reference in the specification to “an example” or similar language means that a particular feature, structure, or characteristic described is included in at least that one example, but not necessarily in other examples.

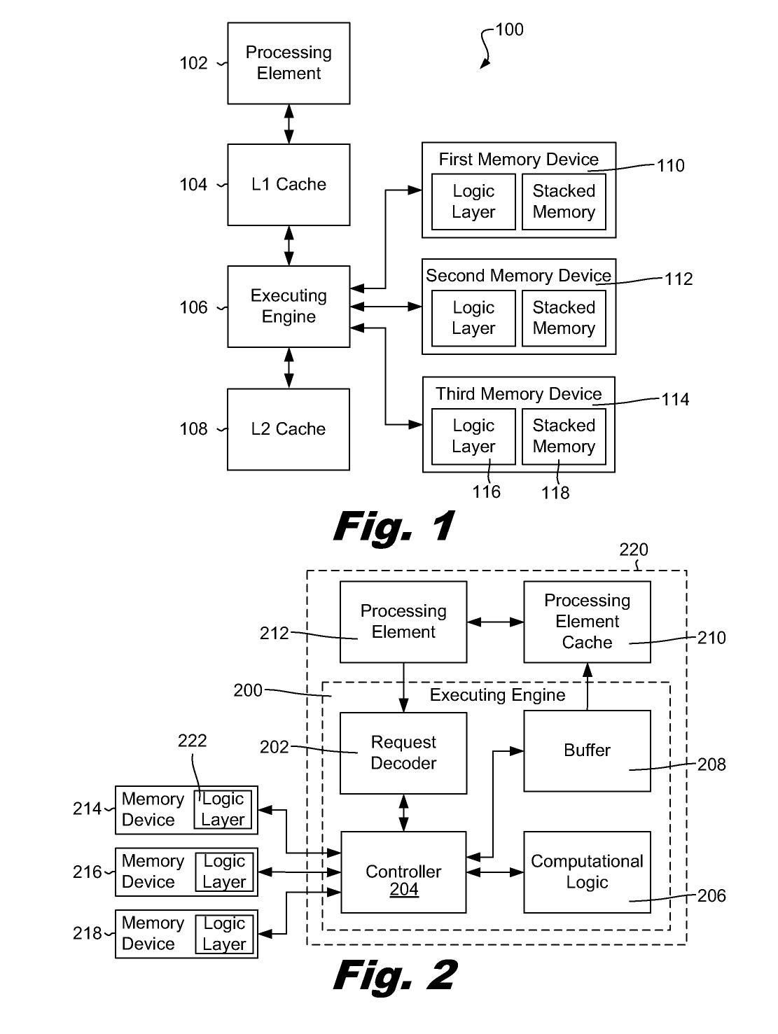

FIG. 1 is a diagram of an example of hardware (100) for executing an indexing request according to the principles described herein. In this example, the hardware (100) includes a processing element (102) that is in communication with a first level cache (L1) (104), an executing engine (106) and a second level cache (108). The executing engine (106) is in communication with multiple memory devices (110, 112, 114) that store indexed information.

The processing element (102) may be a processor, a central processing unit, a general purpose graphics processing unit, another type of processing element, or combinations thereof. The first level cache (104) includes random access memory (RAM) where information is written to be available to the processing element (102). The RAM provides the processor a fast retrieval of information stored therein. The second level cache (108) also stores information that is available to the processing element (102), but from the processing element's perspective, the second level cache's memory is slower to retrieve than the RAM of the first level cache (104) to retrieve data.

The processing element (102) generates an indexing request to search for data stored in the memory devices (110, 112, 114). The indexing requests can include search values and other parameters that are received with the executing engine (106). The executing engine (106) includes hardware and program instructions to initialize the indexing request from the processing element (102). For example, the executing engine (106) can initiate the search by traversing high levels of a data structure to determine which of the memory devices (110, 112, 114) contains information pertaining to the indexing request. The high levels of the data structure may include pointers or links that point to lower levels of the data structure that are distributed across the memory devices. In response to determining the location of the relevant information pertaining to the indexing request, the executing engine (106) forwards the request to the selected memory device to finish traversing the lower levels of the data structure contained within the selected memory device.

In some example, the executing engine (106) determines that more than one memory device contains information that is relevant to the indexing request. As a result, the executing engine (106) forwards the indexing request to multiple selected memory devices. In other examples, the executing engine (106) selects a single memory device to which the indexing request is forwarded. In other examples, the executing engine (106) forwards the indexing request to a single memory device at a time. For example, the executing engine (106) may select a memory device from which to retrieve information relevant to the indexing request. In response to receiving a response from the selected memory device, the executing engine (106) may determine that the response is incomplete and forward the indexing request to another memory device to finalize the response.

The memory devices (110, 112, 114) may be part of a database, a storage network, other storage mechanisms, or combinations thereof. Each of the memory devices (110, 112, 114) includes a logic layer (116) and memory (118) that stores information. The memory (118) may be stacked memory in a memory hierarchy. The memory (118) may be random access memory, dynamic random access memory, static random access memory, read only memory, flash memory, electrically programmable read only memory, memristor memory, other forms of memory, or combinations thereof.

In response to receiving the indexing request from the executing engine (106), the selected memory device continues to search the lower levels of the data structure. Each of the memory devices (110, 112, 114) contains a buffer to store the relevant information during its search of the lower levels of the data structure. Both the relevant and irrelevant information traversed during the search will be stored in the buffers while the memory devices are executing their portion of the indexing request. The logic layer (116) of the memory devices (110, 112, 114) determines whether the traversed data points are relevant. In some cases, the memory devices (110, 112, 114) perform computations based on the data discovered and/or the parameters of the indexing request. In response to finishing their portion of the indexing request, the memory devices (110, 112, 114) send a response to the executing engine (106) with just the relevant data pertaining to the indexing request and/or the corresponding computations.

In response to receiving the responses from each of the selected memory devices, the executing engine (106) finalizes a response for the processing element. The individual responses from the memory devices (110, 112, 114) are stored in a buffer internal to the executing engine (106) while the executing engine (106) finalizes the response. The finalized response includes the relevant data from each of the selected memory devices and their corresponding computations. Further, the executing engine (106) may also perform additional computations that were not completed with the memory devices. In some examples, the executing engine (106) has a capacity to perform additional computations that the memory devices (110, 112, 114) do not have. In other examples, the executing engine (106) performs computations that rely on information that was retrieved from different memory devices.

In response to finalizing the request, the executing engine (106) sends the finalized response to the processing element (102). The principles described herein reduce and/or eliminate the data transfer of irrelevant data between the memory devices and the processing element (102) allowing the processing element (102) to use less power during indexing. Further, the processing element (102) is freed up to execute other tasks while the executing engine (106) and the memory devices (110, 112, 114) are respectively executing their portions of the indexing request. In other examples, the processing element (102) sleeps while the executing engine (106) and the memory devices (110, 112, 114) execute their portions of the indexing request. In such examples, the executing engine (106) may send an interrupt signal to the processing element (102) prior to sending a finalized response to wake up the processing element (102).

While this example has been described with reference to specific hardware and a specific arrangement of the hardware, any appropriate hardware or arrangements thereof may be used in accordance with the principles described herein. Further, while this example has been described with reference to specific types of memory in the caches, buffers, and processing elements, any appropriate type of memory may be used in accordance with the principles described herein. Also, the processing element (102), the first and second level caches (104, 108), and the executing engine (106) may be integrated onto the same chip and be in communication with the memory devices that are located elsewhere. In other examples, at least two of the processing element (102), the first and second level caches (104, 108), and the executing engine (106) are located on different chips, but are still in communication with each other.

Further, while the example of FIG. 1 has been described with reference to indexing requests, any appropriate requests may be used in accordance with the principles described herein. Other suitable requests may include requests that have big data workloads.

FIG. 2 is a diagram of an example of an executing engine (200) according to the principles described herein. In this example, the executing engine (200) includes a request decoder (202), a controller (204), computational logic (206), and a buffer (208). The buffer (208) is in communication with the processing element's cache (210), and the request decoder (202) is in communication with the processing element (212). Further, the controller (204) is in communication with the memory devices (214, 216, 218). The processing element (212), processing element's cache (210), and the executing engine (200) are located on a single chip (220).

The processing element (212) sends the indexing request to the request decoder (202) where the request is decoded. The request decoder (202) sends the decoded request to the controller (204) which executes a portion of the indexing request. The controller (204) initializes the indexing request by starting the search in the higher levels of the data structure that contains the sought after information. The higher levels of the data structure may be stored in a library that is internal to the executing engine (200) or located at a remote location. The higher levels of the data structure include links and/or pointers that direct the controller (204) to the location of at least some of the relevant information pertaining to the indexing request.

In response to determining the location of the relevant information, the controller (204) forwards the indexing request to the memory devices (214, 216, 218) as appropriate to execute the remainder of the indexing request. In this manner, the principles described herein distribute the function of executing the indexing request between portions of the chip (220) and different memory devices. Such a distributed mechanism frees up the resources on the chip for other purposes and/or reduces their energy consumption of the components on the chip, like the processing element, during the execution of the indexing request.

In response to receiving the responses from the individual memory devices (214, 216, 218), the computational logic (206) computes any appropriate computations not already computed in the memory devices (214, 216, 218). Further, the results of the memory devices' searches are stored in the buffer (208) until a finalized response for the processing element is finished. In response to finishing the finalized response, the buffer (208) sends the finalized response to the processing element's cache (210) where the processing element (212) has access to the finalized response.

Each of the memory devices (214, 216, 218) has a logic layer (222) that includes a similar layout to the components of the executing engine (200). For example, each of the memory devices (214, 216, 218) includes a request decoder that decodes the request forwarded from the executing engine (200). Further, the memory devices (214, 216, 218) include a controller that searches the lower levels of the data structure for information relevant to the indexing request. Additionally, a buffer stores information retrieved by the controller of the memory devices. Also, the memory devices (214, 216, 218) include computational logic to perform computations on the retrieved data as appropriate.

When the memory devices (214, 216, 218) determine that their portion of executing the indexing request is complete, the buffers in the memory devices (214, 216, 218) send just the relevant data to the controller (204) of the executing engine (200). Thus, the logic layers (222) of the memory devices (214, 216, 218) are an extension of the functions performed with the executing engine (200).

While this example has been described with reference to specific components and functions of the executing engine, any appropriate components or functions of the executing engine may be used in accordance with the principles described herein. Further, while this example has been described with reference to specific components and functions of the logic layers of the memory devices, any appropriate components or functions of the logic layers may be used in accordance with the principles described herein.

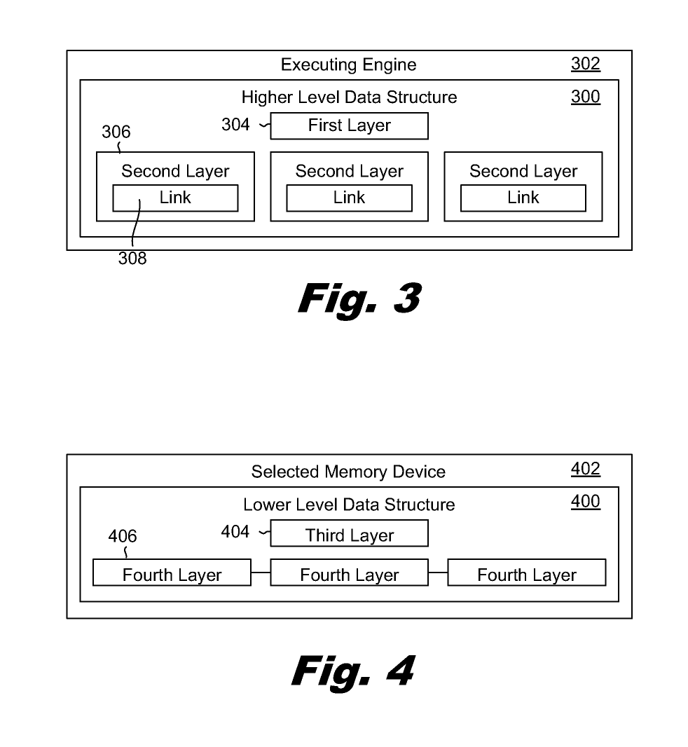

FIG. 3 is a diagram of an example of higher levels of a data structure (300) according to the principles described herein. In this example, the executing engine (302) includes a portion of the data structure (300) which contains a first level (304) of the data structure (300) and a second level (306) of the data structure (300). The data structure (300) has a tree format where each category of information spreads out into subcategories and so forth to form a tree. In this example, the second levels (306) contain links (308) to the third levels that are not stored in the higher levels of the data structure (300).

FIG. 4 is a diagram of an example of lower levels of a data structure (400) according to the principles described herein. In this example, just the data structure of a single memory device (402) is depicted. Here, the lower levels of the data structure (400) include a third layer (404) and a fourth layer (406). As described above in connection with the example of FIG. 3, the data structure (400) in the example of FIG. 4 also includes a tree format.

While the examples above have been described with reference to a specific data structure format, any appropriate data structure may be used in accordance with the principles described herein. For example, the data structure may be a table structure, a columnar structure, a tree structure, a red-black tree structure, a B-tree structure, a hash table structure, another structure, or combinations thereof. Further, while the examples above have been described with reference to specific layers belonging to the higher levels of the data structure and with reference to other specific layers belonging to the lower levels of the data structure, the higher levels and lower levels of the data structure may have any appropriate number of levels according to the principles described herein.

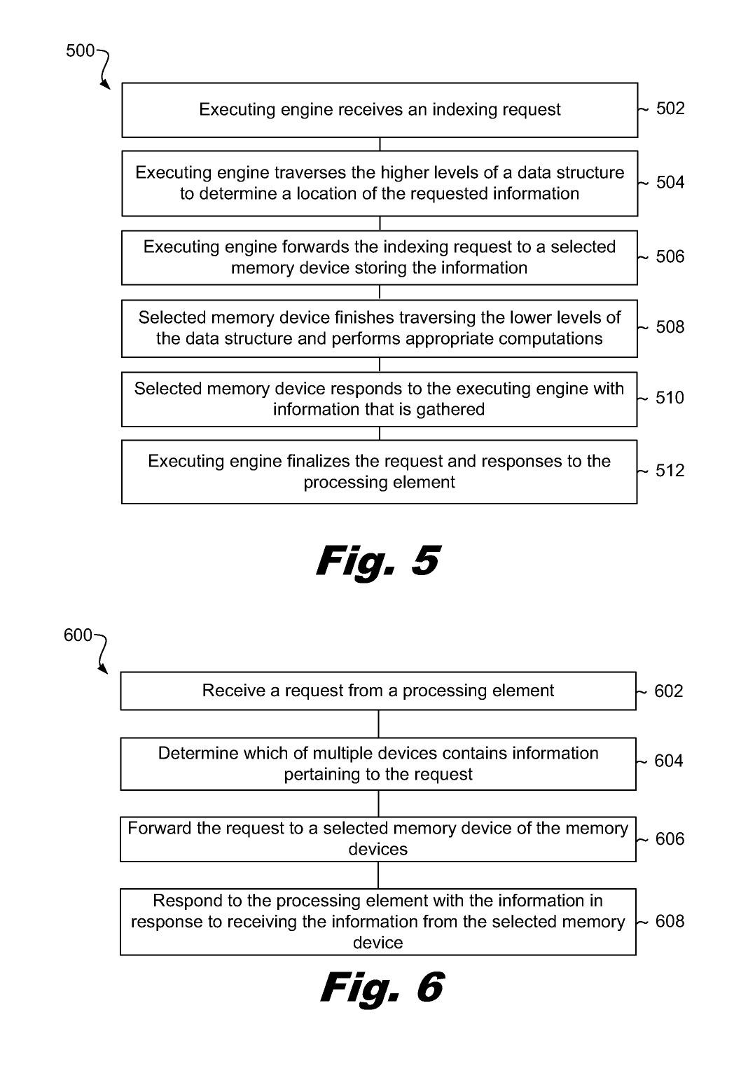

FIG. 5 is a diagram of an example of a method (500) for executing indexing requests according to the principles described herein. In this example, the method (500) includes the executing engine receiving (502) an indexing request and traversing (504) the higher levels of a data structure to determine a location of the requested information. The executing engine forwards (506) the indexing request to a selected memory device that stores relevant information. The selected memory device finishes (508) traversing the lower levels of the data structure and performs appropriate computations. Further, the selected memory device responds (510) to the executing engine with information that is gathered. In response to receiving the gathered information, the executing engine finalizes (512) the request and responds to the processing element.

In some examples, the selected memory devices send just information that is relevant to the indexing request. In other examples, the selected memory devices send all of the information traversed while executing their portion of the indexing request. In such an example, the executing engine determines which of the received information is relevant before sending a finalized response to the processing element.

FIG. 6 is a diagram of an example of a method (600) for executing indexing requests according to the principles described herein. In this example, the method (600) includes receiving (602) a request from a processing element, determining (604) which of multiple devices contains information pertaining to the request, forwarding (606) the request to a selected memory device of the memory devices, and responding (608) to the processing element with the information in response to receiving the information from the selected memory device.

The memory devices contain a logic layer, stacked memory, and a buffer. Such components allow the memory devices to execute a portion of the request. The executing engine coordinates the efforts of the memory devices in executing the request. The executing engine may give more than one memory device the request to execute. In other examples, the executing engine gives at least one of the memory devices just a portion of the request to execute. In response to receiving responses from the memory devices, the executing engine finishes undone portions of the request based on the information received from the selected memory devices.

In response to receiving the request from the processing element, the executing engine performs at least one traversal of a high level of a data structure that identifies where the information is stored in the memory devices. The high level of the data structure is stored in a library that contains links to the lower levels of the data structure. The lower levels of the data structure are stored across the memory devices.

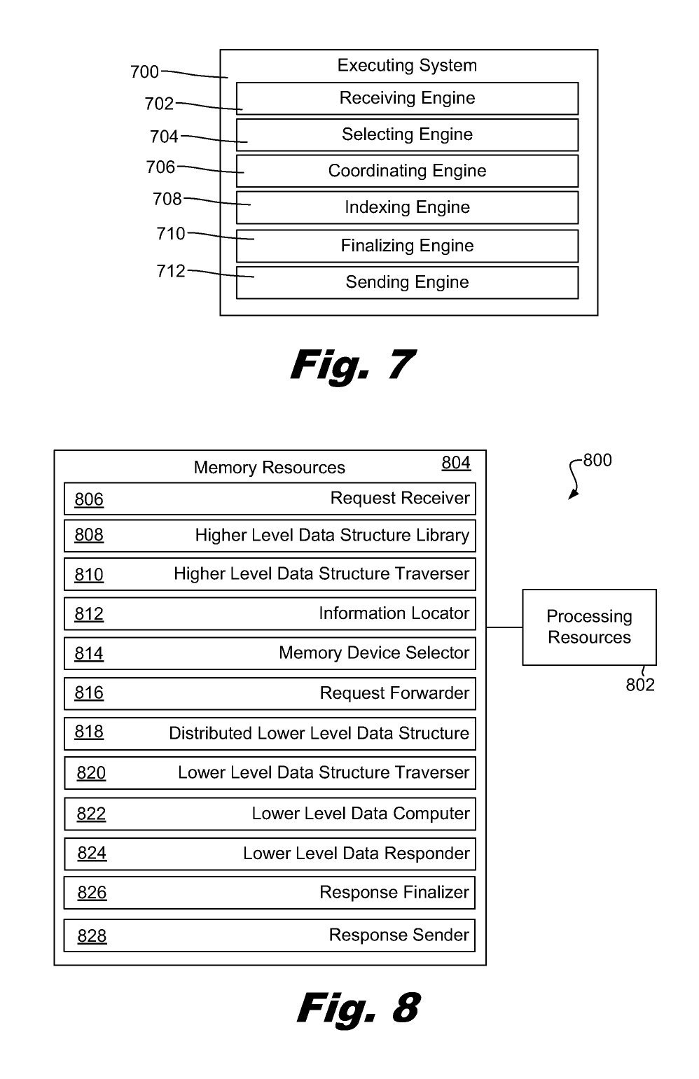

FIG. 7 is a diagram of an example of an executing system (700) according to the principles described herein. In this example, the executing system (700) has a receiving engine (702), a selecting engine (704), a coordinating engine (706), an indexing engine (708), a finalizing engine (710), and a sending engine (712). The engines (702, 704, 706, 708, 710, 712) refer to a combination of hardware and program instructions to perform a designated function. Such hardware and program instructions may be distributed across the chip (220, FIG. 2) and the memory devices (214, 216, 218, FIG. 2). Each of the engines (702, 704, 706, 708, 710, 712) may include a processor and memory. The program instructions are stored in the memory and cause the processor to execute the designated function of the engine.

The receiving engine (702) receives the request from the processing element. The selecting engine (704) selects the memory devices or devices to which the coordinating engine (706) forwards the request. The indexing engine (708) of the memory devices traverses their respective data structures to find information relevant to the request. The finalizing engine (710) finalizes a response to the processing element based on the information gathered from the memory devices. The sending engine (712) sends the finalized request to the processing element.

FIG. 8 is a diagram of an example of an executing system (800) according to the principles described herein. In this example, the executing system (800) includes processing resources (802) that are in communication with memory resources (804). The processing resources (802) and the memory resources (804) may be distributed across the chip (220, FIG. 2) and the memory devices (214, 216, 218, FIG. 2). Processing resources (802) include at least one processor and other resources used to process programmed instructions. The memory resources (804) represent generally any memory capable of storing data such as programmed instructions or data structures used by the executing system (800). The programmed instructions shown stored in the memory resources (804) include a request receiver (806), a higher level data structure traverser (810), an information locator (812), a memory device selector (814), a request forwarder (816), a lower level data structure traverser (820), a lower level data computer (822), a lower level data responder (824), a response finalizer (826), and a response sender (828). The data structures shown stored in the memory resources (804) include a higher level data structure library (808) and a distributed lower level data structure (818).

The memory resources (804) include a computer readable storage medium that contains computer readable program code to cause tasks to be executed by the processing resources (802). The computer readable storage medium may be tangible and/or non-transitory storage medium. The computer readable storage medium may be any appropriate storage medium that is not a transmission storage medium. A non-exhaustive list of computer readable storage medium types includes non-volatile memory, volatile memory, random access memory, memristor based memory, write only memory, flash memory, electrically erasable program read only memory, or types of memory, or combinations thereof.

The request receiver (806) represents programmed instructions that, when executed, cause the processing resources (802) to receive the request from the processing element. The higher level data structure traverser (810) represents programmed instructions that, when executed, cause the processing resources (802) to traverse the higher level data structure library (808). The information locator (812) represents programmed instructions that, when executed, cause the processing resources (802) to determine the location of information relevant to the request from the higher level data structure library (808). The memory device selector (814) represents programmed instructions that, when executed, cause the processing resources (802) to select a memory device to forward the request based on the location of the relevant information.

The request forwarder (816) represents programmed instructions that, when executed, cause the processing resources (802) to forward the request to the selected memory devices. The lower level data structure traverser (820) represents programmed instructions that, when executed, cause the processing resources (802) to traverse the respective portions of the lower level data structure (818) distributed across the memory devices. The lower level data computer (822) represents programmed instructions that, when executed, cause the processing resources (802) to compute appropriate computations at the selected memory devices. The lower level data responder (824) represents programmed instructions that, when executed, cause the processing resources (802) to responses with the relevant information found at the memory devices.

The response finalizer (826) represents programmed instructions that, when executed, cause the processing resources (802) to finalize a response for the processing element. The response sender (828) represents programmed instructions that, when executed, cause the processing resources (802) to send the response to the processing element.

Further, the memory resources (804) may be part of an installation package. In response to installing the installation package, the programmed instructions of the memory resources (804) may be downloaded from the installation package's source, such as a portable medium, a server, a remote network location, another location, or combinations thereof. Portable memory media that are compatible with the principles described herein include DVDs, CDs, flash memory, portable disks, magnetic disks, optical disks, other forms of portable memory, or combinations thereof. In other examples, the program instructions are already installed. Here, the memory resources can include integrated memory such as a hard drive, a solid state hard drive, or the like.

In some examples, the processing resources (802) and the memory resources (804) are located within the same physical component, such as a server, or a network component. The memory resources (804) may be part of the physical component's main memory, caches, registers, non-volatile memory, or elsewhere in the physical component's memory hierarchy. Alternatively, the memory resources (804) may be in communication with the processing resources (802) over a network. Further, the data structures, such as the libraries, may be accessed from a remote location over a network connection while the programmed instructions are located locally. Thus, the executing system (800) may be implemented on a user device, on a server, on a collection of servers, or combinations thereof.

The executing system (800) of FIG. 8 may be part of a general purpose computer. However, in alternative examples, the executing system (800) is part of an application specific integrated circuit.

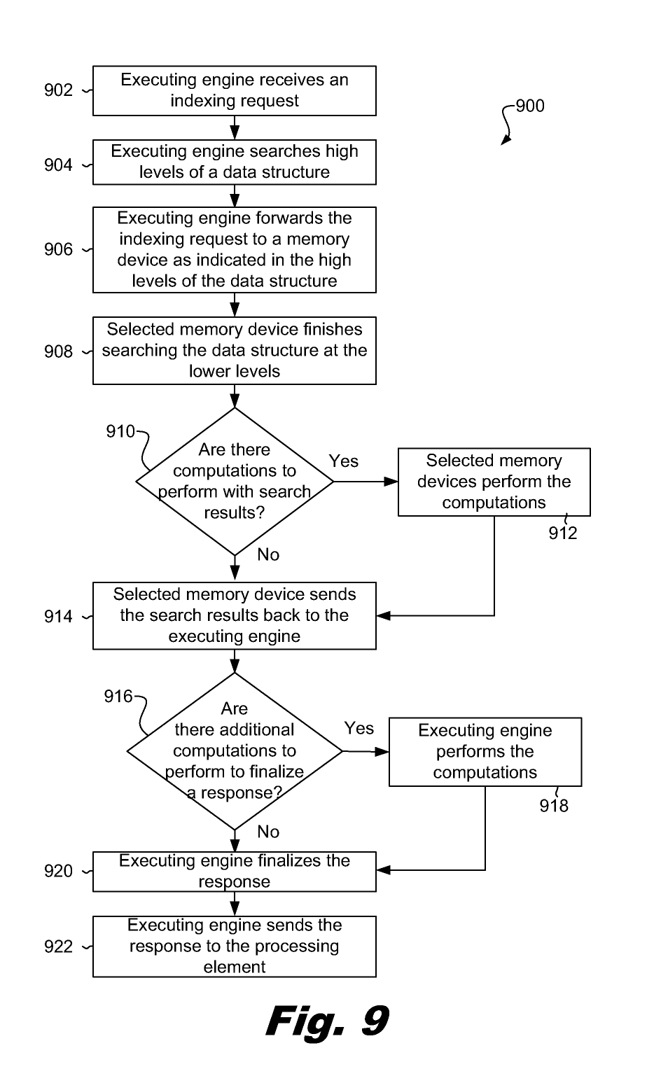

FIG. 9 is a diagram of an example of a flowchart (900) of a process for executing indexing requests according to the principles described herein. In this example, the process includes the executing engine receiving (902) an indexing request and searching (904) high levels of a data structure in response to receiving the request. The executing engine forwards (906) the indexing request to a memory device as indicated in the high levels of the data structure.

The selected memory devices finish (908) searching the data structure at the lower levels and determine (910) whether there are computations to perform. If there are computations to perform, the selected memory devices perform (912) the computations. If there are not computations to perform, the selected memory devices send (914) the results back to the executing engine.

The executing engine determines (916) whether there are additional computations to perform to finalize a response. If such additional computations are outstanding, the executing engine performs (918) the computations. The executing engine finalizes (920) the response and sends (922) the response to the processing element.

While the examples above have been described with reference to specific method and mechanism for executing a request, any appropriate method or mechanism may be used to execute a request according to the principles described herein. While the executing engine and the memory devices have been described above with reference to specific layouts and architectures, any appropriate layout or architectures may be used according to the principles described herein.

The preceding description has been presented only to illustrate and describe examples of the principles described. This description is not intended to be exhaustive or to limit these principles to any precise form disclosed. Many modifications and variations are possible in light of the above teaching.

What is claimed is:

1. A method for executing requests from processing elements with stacked memory devices, comprising:
receiving a request from a processing element;
determining which of multiple memory devices contains information pertaining to said request;
forwarding said request to a selected memory device of said memory devices; and
responding to said processing element with said information in response to receiving said information from said selected memory device.

2. The method of claim 1, wherein said request is an indexing request.

3. The method of claim 1, wherein determining which of said multiple memory devices contains said information pertaining to said request includes performing at least one traversal of a high level of a data structure that identifies where said information is stored.

4. The method of claim 3, wherein said high level of said data structure is stored in a library that contains links to lower levels of said data structure which are stored across said memory devices.

5. The method of claim 4, wherein responding to said processing element with said information in response to receiving said information from said selected memory device includes sending said information found with said selected memory device through traversing said lower levels of said data structure.

6. The method of claim 1, wherein responding to said processing element with said information in response to receiving said information from said selected memory device includes finishing undone portions of said request based on information received from said selected memory device.

7. The method of claim 1, wherein said memory devices contain a logic layer and stacked memory.

8. The method of claim 1, wherein said memory devices contain a buffer.

9. A system for executing requests from processing elements with stacked memory devices, comprising:
a requesting engine to send an indexing request to a coordinating engine;
a selecting engine to select a selected memory device from multiple memory devices containing information pertaining to said indexing request;
said coordinating engine to forward requests to said multiple memory devices to retrieve said information;
indexing engines incorporated into each of said memory devices to send said information to a finalizing engine; and
said finalizing engine to finalize said request based on said information.

10. The system of claim 9, further comprising a sending engine to send a response to said requesting engine based on results of said finalizing engine.

11. The system of claim 9, wherein said selecting engine performs traversals of higher levels of a data structure to determine a location of said information.

12. The system of claim 11, wherein said indexing engines perform traversals at lower levels of said data structure.

13. The system of claim 12, wherein said higher levels of said data structure are stored in a library and said lower levels of said data structure are stored across said multiple memory devices.

14. A computer program product for executing requests from processing elements with stacked memory devices, comprising:
a non-transitory computer readable storage medium, said non-transitory computer readable storage medium comprising computer readable program code embodied therewith, said computer readable program code comprising program instructions that, when executed, causes a processor to:
receive an indexing request;
select a selected memory device from multiple memory devices containing information pertaining to said indexing request;
forward requests to said multiple memory devices to retrieve said information;
send said information to a finalizing engine;
finalize said request based on said information; and
send a response to said requesting engine based on results of said finalizing engine.

15. The computer program product of claim 14, further comprising computer readable program code comprising program instructions that, when executed, cause said processor to link higher levels of a data structure stored in a library to lower levels of said indexing structure distributed across said multiple memory devices.
